(19) United States
(12) Patent Application Publication
(10) Pub. No.: US 2013/0174013 A1
(43) Pub. Date: Jul. 4, 2013

(54) WIKI MONITORING AND UPDATING

(71) Applicants: Lisa Seacat DeLuca, San Francisco, CA (US); Robert Ross Peterson, Austin, TX (US)

(72) Inventors: Lisa Seacat DeLuca, San Francisco, CA (US); Robert Ross Peterson, Austin, TX (US)

(73) Assignee: INTERNATIONAL BUSINESS MACHINES CORPORATION, Armonk, NY (US)

(21) Appl. No.: 13/343,600

(22) Filed: Jan. 4, 2012

(51) Int. Cl. G06F 17/00

(52) U.S. Cl. 715/234

(57) ABSTRACT

A method for monitoring and updating a wiki includes associating a portion of the wild with a reference by identifying the reference, displaying information from the reference in the portion of the wiki and monitoring the reference for change. If a change is detected, the wiki reports to the user that a reference has changed. The user is presented with options to update portions of the wiki that are associated with the reference. If the user accepts an option to update portions of the wiki associated with a reference that has changed, then the wiki is updated.

### BACKGROUND

A wiki is a website that allows for the creation and editing of a number of interlinked web pages. Wiki systems allow users to collaboratively share information with each other through creating, updating and editing wiki articles. Typically any web enabled device that provides the proper authentication can be used to access and contribute to the wiki.

Wikis can be especially useful in distributed projects and many teams around the world use them to organize, track, and publish their work. A wiki is a flexible tool that can change in response to the evolving needs of the project. In one example, a wiki can be used to provide documentation during development and maintenance of software programs. The documentation stored on the wiki can be adapted collaboratively as the software evolves and more versions are released.

### BRIEF SUMMARY

A method includes associating a portion of a wiki hosted by a computing device with an electronic reference, displaying information from the reference in the portion of the wiki, and monitoring the reference for change. If a change is detected, the wiki reports to the user that a reference has changed. The user is presented with options to update portions of the wiki that are associated with a reference that has changed. If the user accepts an option to update portions of the wiki associated with a reference that has changed, then updating the portion of the wiki.

A system includes a wiki hosted by a computing device, a wiki reference tool configured to associate selected portions of a wiki with references, and a wiki update tool implemented configured to monitor references associated with portions of the wiki for changes. A change notification is generated by the wiki update tool and presented to the user when the wiki update tool detects a change in one of the references associated with the wiki.

A computer program product for implementing a wiki includes a computer readable storage medium having computer readable program code embodied therewith, the computer readable program code including computer readable program code configured to associate a portion of a wiki with a reference and display information from the reference in the portion of the wiki. The computer readable program code if further configured to monitoring the reference for change and to update the portion of the wiki if a change is detected.

### BRIEF DESCRIPTION OF THE SEVERAL VIEWS OF THE DRAWINGS

The accompanying drawings illustrate various embodiments of the principles described herein and are a part of the specification. The illustrated embodiments are merely examples and do not limit the scope of the claims.

FIGS. 1A and 1B are diagrams of an illustrative wiki editor, according to one example of principles described herein.

FIG. 2A is a diagram of an illustrative wiki editor associating a reference with a portion of wiki text, according to one example of principles described herein.

FIG. 2B is a diagram of a website referenced by the wiki, according to one example of principles described herein.

FIG. 2C is a diagram of an illustrative wiki editor displaying change notification options, according to one example of principles described herein.

FIG. 2D is a diagram of an illustrative change notification, according to one example of principles described herein.

FIG. 3 is a flow chart of an illustrative method for associating a reference with content in a wiki, monitoring the reference for changes, and updating the wiki, according to one example of principles described herein.

FIG. 4A is a flow chart of an illustrative method for associating a reference with content in a wiki, according to one example of principles described herein.

FIG. 4B is a flow chart of an illustrative method for monitoring references associated with a wiki, according to one example of principles described herein.

FIG. 5 is a block diagram of an illustrative system for associating references with a wiki, monitoring the references, and updating the wiki when a reference changes, according to one example of principles described herein.

Throughout the drawings, identical reference numbers designate similar, but not necessarily identical, elements.

### DETAILED DESCRIPTION

A wide variety of information can be presented on wikis, including some information that becomes outdated over time. For example, information that may become outdated in a wiki may include hyperlinked material, data supplied by outside sources, references to software version numbers, and other information. The present specification discloses systems and methods for monitoring and updating material in a wiki.

The principles described below can be applied to a wide range of wikis and websites. As discussed above, wikis can be especially useful in distributed projects such as software development. The various teams developing the software can collaboratively communicate software requirements, design, implementation, verification and maintenance using a wiki. The documentation stored on the wiki evolves as the software matures and more versions are released. Each member of the software team may develop specialized knowledge related to the software and capture this knowledge on the wiki. The software team can use the wiki as a primary reference to coordinate actions and ensure the various portions of the software work cooperatively. However, keeping the wiki up to date can be a time consuming and ongoing manual task. To keep the wiki up to date, a team member identifies portions of the wiki that may need to be updated, accesses third party information to determine if the wiki reference is outdated, and transfers data from the third party information to back to the wiki. This process is repeated throughout the wiki, which may include thousands of pages of documentation on a regular basis. An updated wiki can be particularly valuable when a software developer leaves the team.

For example, the wiki documentation may include references to third-party applications that are used in conjunction with the software. The third parties periodically release new versions of the applications. To keep the wiki updated, a team member must manually identify all references to third party applications, contact each of the third parties to determine if new versions of the applications have been released, and then make the appropriate updates to each of the references contained in the wiki. This method of manually updating wikis is inefficient for a number of reasons that go beyond the time and effort to actually make the necessary changes. For example, an original user may leave the project or be reassigned to a new team. A new team member is then assigned to maintain the wiki documentation. The new user may not know which information in the wiki will likely become outdated or where to go to update the information. This can result in significant degradation of the wiki.

As will be appreciated by one skilled in the art, aspects of the present invention may be embodied as a system, method or computer program product. Accordingly, aspects of the present invention may take the form of an entirely hardware embodiment, an entirely software embodiment including firmware, resident software, micro-code, etc. or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable storage medium may be transmitted using any appropriate medium, including but not limited to wireless, wireline, optical fiber cable, RF, etc., or any suitable combination of the foregoing.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

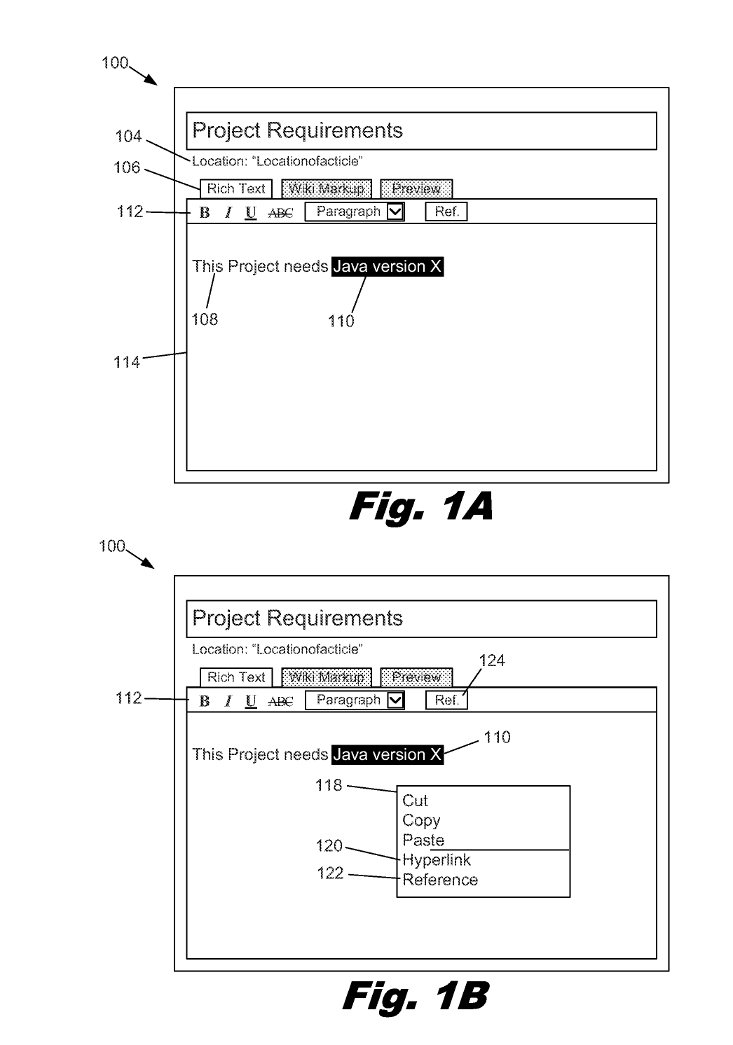

FIG. 1A is an illustrative screenshot of a wiki editor (100) used to create and edit content for a wiki used in a software development project. In this case, the wiki article is titled “Project Requirements” and is located at “Locationofarticle.” A number of tabs (106) provide access to various views and functions within the wiki editor (100). In this example, the “Rich Text” tab has been selected, which brings up a tool bar (112) and text box (114). The tool bar (112) includes various functions related to text entry and formatting. The text (108, 110) is entered and formatted in the text box (114). In this example, the wiki user has entered the text “This project needs Java version X” to define one project requirement. The text (108, 110) includes a first portion (108) which states “This project needs” and a highlighted second portion (110) which states “Java version X.” This second portion (110) refers to the latest version of Java®. Like other software programs, Java is periodically updated. For example, Java was first released in 1996 and released seven subsequent versions and numerous updates in the following 14 years. Oracle®, the current owner of Java, plans to continue with quarterly updates. Consequently, the reference to Java should also be updated to accurately to reflect the latest Java version number. As discussed above, a wiki may contain hundreds of elements that need updating. Manually updating these elements is a tedious process that depends on the human editor to identify elements that need updating, find the correct information, and enter the correct information in the wiki.

FIG. 1B shows a variety of methods that can be used by the user to associate a portion of the wiki text with a reference. The reference may be within the wiki itself, within the local computer system, or an external reference. In this example, the second portion (110) of the text has been highlighted. This highlighted portion can be associated with an outside reference in a variety of ways. For example, the tool bar (112) may include a reference button (124). By highlighting text (110) and selecting the reference button (124) the user can bring up a dialog that allows the user to designate an outside connection and other relevant parameters.

In the example shown in FIG. 1B, the user has highlighted the second portion (110) of the text and right clicked or double clicked to bring up a menu (118). The menu (118) includes a variety of options including cut, copy, paste, hyperlink (120), and reference (122). The hyperlink function (120) allows for a static connection between the text and an outside reference. If the hyperlink function were pressed, the highlighted text (110) would become clickable by a reader of the wiki and, when clicked, would take the reader to a designated location. For example, the hyperlink could take the user to an outside website for Java®. However, in many instances taking the user away from the wiki to outside locations can be a distraction and expose the reader to extraneous information. In this case, all the reader needs to know is that one of the project requirements is to have a particular version of Java® installed. The reference option (122), whether selected from the tool bar (1.1.2), from the menu (118), or through another method, allows for additional options beyond the simple hyperlink

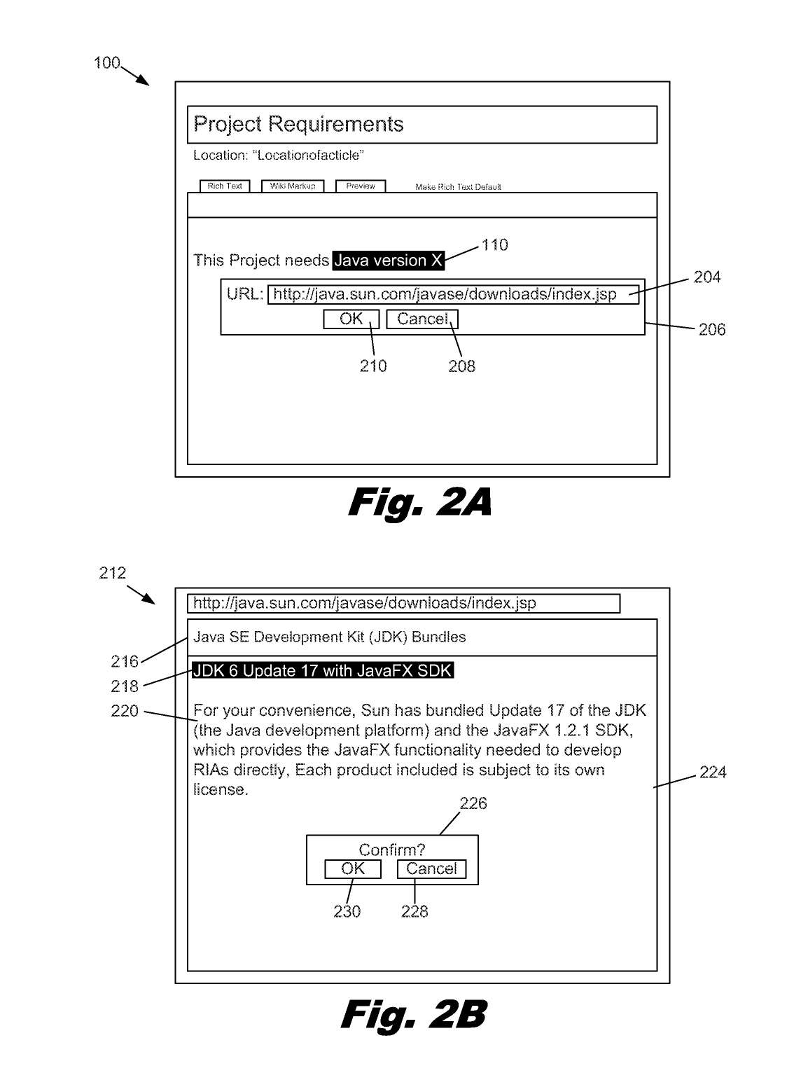

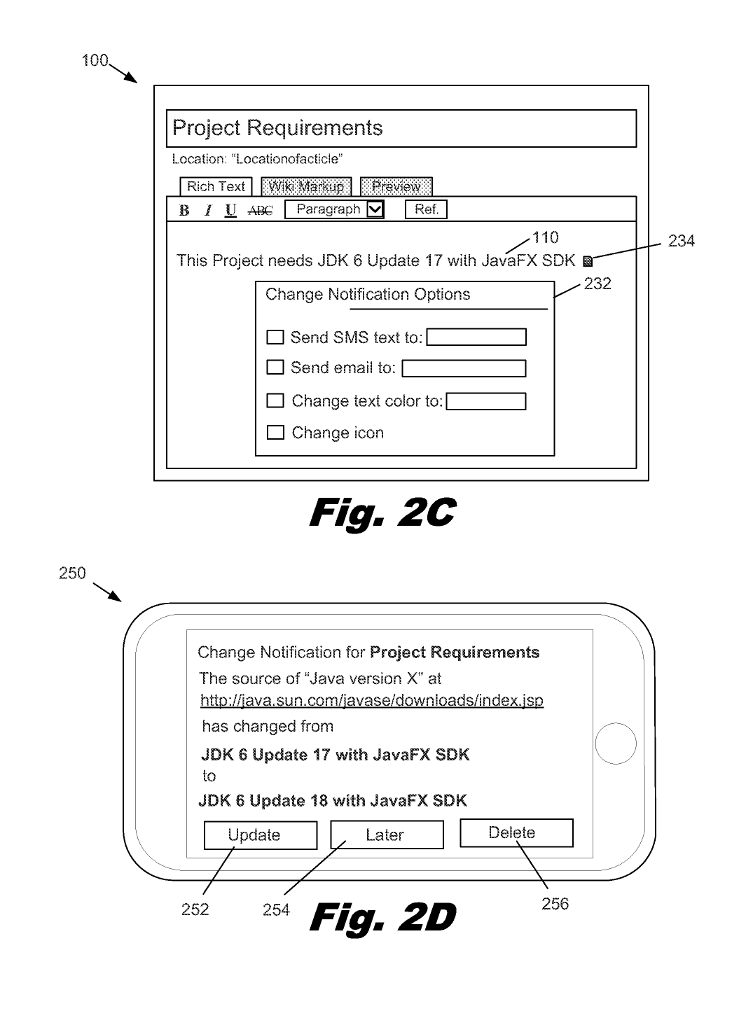

FIGS. 2A-2D illustrate one method for associating text in the wiki with an outside reference and then updating the reference. FIG. 2A is a wiki editor that shows a prompt (206) for entering a Uniform Resource Locator (URL) (204), file path, or other location of material that can be associated with the highlighted text (110). After the desired location is entered, the user can confirm the entry by pressing the OK button (210) or by pressing the cancel button (208). The wiki editor then takes the user to the designated location as shown in FIG. 2B.

FIG. 2B shows a web browser (212) that is displaying the URL entered in FIG. 2A. In this example, the website describes development software which is required for the software development project. The webpage includes a title (216), a subtitle (218), and body text (220). Each of these elements may be identified in the Hypertext Markup Language (HTML) using appropriate tags such as <head>, <title>, <h1>, <body>, <img> or other tags. In addition to the basic tags, other identifying tags such as style attributes and classnames could be used to identify the element such as <p class=“style1”, <span class=“Versionnamestyle”, <p style=“font-weight:bold” or other styles. The user is then prompted to select a portion of the webpage for display on the wiki. The user may select a variety of content from the webpage, including text, titles, pictures, videos, hyperlinks, or other material. In this example, the user has selected a subtitle (218) of the webpage by highlighting it. Once this text has been selected, a confirmation box (226) is displayed so that the user can confirm and continue by pressing the OK button (230), change the selection by highlighting a different portion of the text above, or select the cancel button (228). If the user chooses to cancel the action due to incorrect data or URL, the user is returned to the wiki editing view.

The portion of the webpage selected by the user is then displayed on the wiki editor (100) as shown in FIG. 2C. The second portion of the text (110) which originally read “Java version X” has been replaced by “JDK 6 Update 17 with JavaFX SDK.” Portions of the text that are drawn from referenced sources can be identified in a number of ways. This identification may or may not be visible. For example, the HTML code of the wiki may identify the referenced portion with a tag, the URL of the reference, and/or the location within the reference the text was drawn from. The location within the reference may be identified using tag information, page location, content, or other appropriate information. A visual indication of referenced element can be displayed as an alteration of the referenced element itself or through an additional element. For example, if the referenced element is text, the size, color, or font of the text may be altered to indicate that it is referenced from an outside source. Additionally or alternatively, an icon (234) can be placed next to the text. This icon may simply be a visual representation that the text is referenced from an outside source or may have underlying functionality. For example, the icon (234) may be selected to take the user to the source or may open a history of the referenced text.

After the referenced information has been selected and displayed on the wiki editor (100), a wiki update tool may present a variety of change notification options (232) to the user. These change notification options (232) provide the user with notification when the source document has been changed and provide the user with an opportunity to update the referenced information. The change notification may include sending an SMS text message, sending an email, or visually changing the presentation of the wiki by altering the text (110) or changing the icon (234). For example, the text associated with a changed reference could be altered by using a different font, different font size, different font color, underlining the text, highlighting the text or other appropriate alternation.

A variety of other options could be included, such as automatically updating the wiki or taking no action when a change is detected. Some users may prefer to receive immediate notification when one or more of the referenced documents are changed. Other users may prefer to receive a single notification on a periodic basis with all of changes that have taken place since the last notification. Additionally or alternatively, the references that have changed could be visually indicated in the wiki itself. This may have a number of advantages, including allowing the user to view the referenced element in context and make a more informed updating decision. In some embodiments, the visual indications that references have changed may be distracting to other users. To avoid this, the visual indications could be toggled on and off or only be visible to the user.

FIG. 2D shows an updated email generated by the wiki and sent to a mobile device (250). The change notification may identify the wiki, the referenced element, the location of the reference, and/or the content in the reference which has changed. A variety of other information may also be included. In this example, the change notification identifies the wiki as “Project Requirements,” the referenced element as “Java version X”, the location of the reference as “http://java.sun.com/javase/downloads/index.jsp” and that the text “JDK 6 Update 17 with JavaFX SDK” has changed to “JDK 6 Update 18 with JavaFX SDK.” The user can then evaluate the change to determine if updating the text on the wiki is justified. For example, the user may click on the hyperlink to go to the Java® webpage and determine if the current software project actually requires the new update. If the software project requires the update, the user can select the “Update” button (252) to automatically include the updated element in the wiki. If the user determines that the software project may require the new Java version in the future, the user could select the “Later” button (254). However, the user may also determine that the new Java version has changes that will not be beneficial to the software project and select the “Delete” button (256).

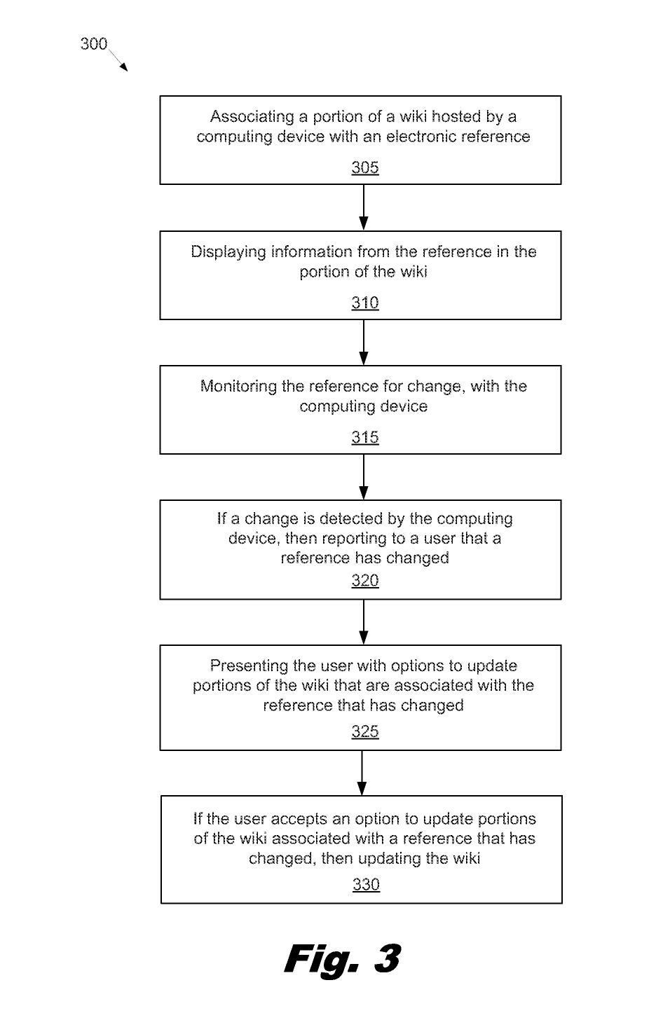

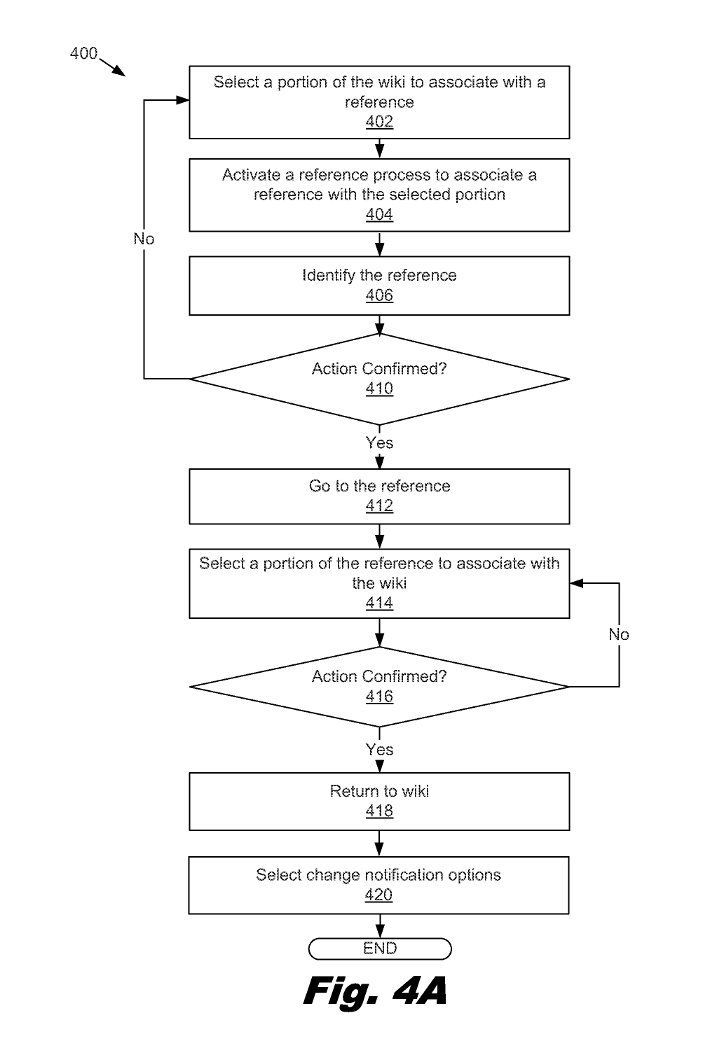

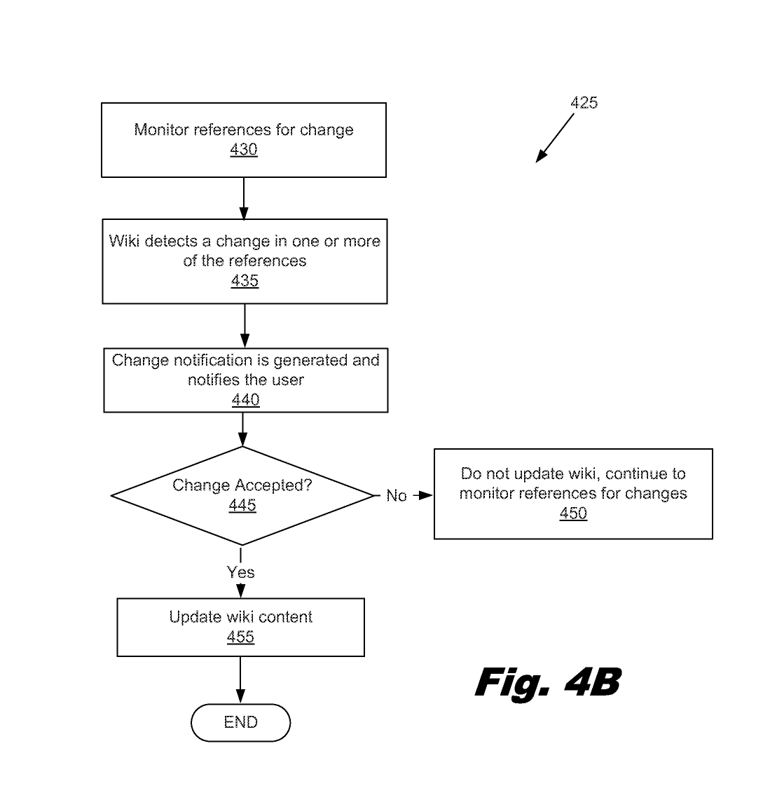

FIG. 3 is a flow chart of an illustrative method (300) for associating a reference with content in a wiki, monitoring the reference for changes, and updating the wiki, according to one example of principles described herein. A portion of a wiki hosted by a computing device is associated with an electronic reference (block 305). Information from the reference is displayed in the wiki (block 310). The reference is monitored for change by computing device (block 315). If a change is detected by the computing device, a report is sent to a user that the reference has changed (block 320). The user is presented with options to update portions of the wiki that are associated with the reference that has changed (block 325). If the user accepts an option to update portions of the wiki associated with a reference that has changed, then the wiki is updated (block 330), FIGS. 4A and 4B describe illustrative implementations of the method shown in FIG. 3.

FIG. 4A is a flow chart of an illustrative method (400) for associating a portion of a wiki with a reference. The reference may be a third party website, an internal website, a file, and a document, a different part of the same wiki, a different wiki, or other source. A portion of the wiki is selected to associate with the reference (block 402). A wiki reference tool is activated to associate the reference with the selected portion (block 404). For example, the wiki reference tool can be started by selecting a button on a tool bar, bringing up a menu by right clicking, or other suitable action. The wiki reference tool prompts the user to identify the reference (block 406). The user can identify the reference using a wide range of methods, including entering a URL, file path, IP address, FTP site, or opening the reference in a new window. The user is then prompted to confirm the identification of the reference (decision 410). If the identification of the reference is not confirmed, the wiki reference tool returns to the wiki and the user is free to continue viewing/editing the wiki or to start the process for associating a reference with the wiki again. If the action is confirmed, the user is taken to the reference (block 412) where the user selects a portion of the reference to associate with the wiki (414). In some examples, the user may select a specific element from the reference, such as text, a picture, HTML code, graph, video, equation, or other element. In other examples, the user may select the entire reference, data within the reference, or third party elements that are pointed to within the reference. The user can make the selection within the reference by clicking and dragging, double clicking, single clicking, highlighting, or other appropriate action.

The user is then prompted to confirm the selection within the reference (decision 416). If the user does not confirm the selection, the user is returned to the reference to make another selection. If the user confirms the selection, the user is returned to the wiki (block 418) where the selected portion of the reference is displayed in the wiki. The user may also be prompted to select change notification options (block 420).

The method for associating a reference with a wiki is only one illustrative example. The blocks in the method could be added, changed, reordered or eliminated. For example, there may be an additional block added to the method which describes manipulation of the element or elements selected from the reference before the element is displayed on the wiki. For example, if a picture is selected from the reference, the picture may be resized prior to display on the wiki. If data is selected from the reference, a number of mathematical or organizational steps may be taken prior to displaying the data on the wiki. Similarly, the font, style, size and markup of text can also be altered prior to displaying it on the wiki.

FIG. 4B is a flow chart of an illustrative method (425) for monitoring changes in references that are linked to the wiki. A wiki update tool monitors the references that are associated within the wiki (block 430). When the wiki update tool detects a change in one or more of the references (block 435), the wiki update tool generates a change notification and notifies the user (block 440). As discussed above, the notification can be a text message, an email, a visual representation on the wiki, or other notification. The user has the option of allowing the wiki update tool to automatically update the portion that is associated with the changed reference or asking the user to confirm the change (decision 445). If the user rejects the change (“No”), the portion of the wiki associated with the changed reference is not updated and the wiki update tool continues to monitor the references for additional changes (block 450). If the change is accepted (“Yes”), the portion of the wiki associated with the changed reference is updated (block 455). According to one example, the references which have changed are noted directly in the wiki. When a user scrolls over portions of the wiki associated with a changed reference, a wiki update tool may display the changed information directly to the user without requiring the user to open the original source. The user can then make a quick decision about the change. If more information is needed the user can then go directly to the reference.

The method described above for monitoring and updating references within a wiki is only one illustrative example. The blocks in the method could be added, changed, reordered or eliminated. For example, there may be an additional block added to the method which the wiki update tool applies predetermined rules, fuzzy logic, or accesses outside decision making to determine which portions of the wiki should be updated. For example, the wiki may present to the user only the first instance in the wiki that is associated with a changed reference. After the user makes decision about updating the first instance, the wiki can automatically update all of the following portions that are associated with same changed reference. In another embodiment, the wiki may compile an index of all referenced documents and indicate on the index which references have changed. The user can then go through the highlighted changes in the index and the wiki is automatically updated based on the decisions that the user makes while viewing the index.

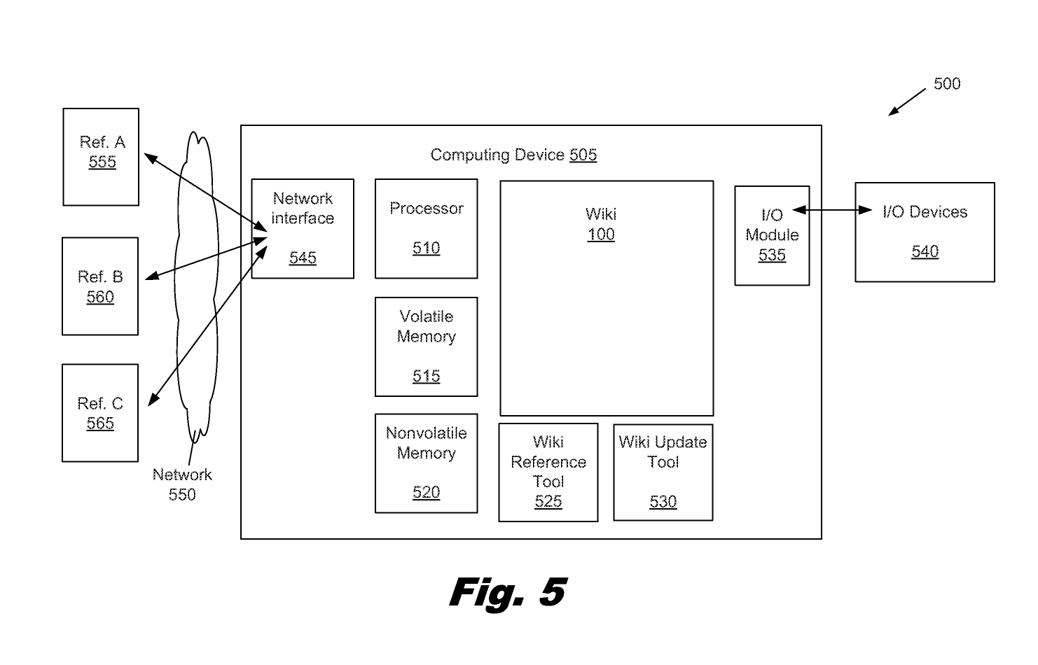

FIG. 5 is simplified diagram of a system (500) for creating and maintaining a wiki according to principles described above. A computing device (505) includes a processor (510), a volatile memory (515), and a nonvolatile memory (520). The nonvolatile memory (520) stores computer readable instructions for the operation of the processor and the volatile memory (515) stores information for quick access by the processor (510). The computing device (505) also includes a network interface (545) that is configured to access various reference documents (555, 560, 565) through a network (550). An input/output (I/O) module (535) sends signals to and receives signals from various I/O devices (540). These I/O devices may include a monitor, keyboard, mouse, touch screen, speaker, microphone, or other external devices such as external storage, dongles, specialized tools, and other devices.

In this example, the computing device (505) is hosting a wiki (100), a wiki reference tool (525) and a wiki update tool (530). As discussed above, the wiki may include portions that are associated with one or more references (555, 560, 565). The wiki reference tool (525) performs functions to allow portions of the wiki to be selected and associated with a particular reference as described in FIG. 3. For example, the wiki reference tool (525) allows the user to highlight a portion of the wiki using a peripheral device and then designate the location of a reference (555). The wiki reference tool (525) accesses the reference (555) through the network interface (545) and displays the reference on an output device through the I/O module (535). The user then selects a portion of the reference (555) to be associated with the wiki and confirms the selection. The material from the reference (555) is then displayed to the wiki (100). The wiki reference tool (525) also may provide change notification options which can be set by the user.

The wiki update tool (530) monitors the references (555, 560, 565) for changes, notifies the user of changes, accepts feedback from the user and updates the wiki as described in FIG. 4. The wiki update tool (530) may monitor the references (555, 560, 565) for changes by maintaining an index of the references and periodically accessing the references through the network interface to check for changes. For example, the wiki update tool (530) may periodically access the references and scrape the information from the reference to compare with a stored copy of the references. In one implementation, any change that is detected to the web page is reported as a change. For example, if the “document.lastModified” tag in an HTML document has changed, the wiki update tool reports a change to the user.

Alternatively, the wiki update tool (530) may apply one or more rules or thresholds to determine if the change to the webpage is significant enough to report to the user. For example, the wiki update tool (530) may only report a change if the actual material referenced by the wiki changes. All other portions of the reference are ignored. Additionally, the wiki update tool (530) may monitor the references to determine if the reference still exists at the designated location. This will mitigate “dead links” in the wiki. In other embodiments, the wiki update tool may include a web-browsing robot that continuously monitors the reference pages for changes.

The wiki update tool (530) may notify the user of changes to the reference in a variety of ways, including through automatically generating a text or an email. The text or the email may be sent through the network interface (545). The wiki update tool (530) may also alter the content or visual display of the wiki to notify the user that specific portions of the wiki associated with a changed reference are no longer current. The wiki is displayed to the user through the I/O module and a monitor or other visual display. The wiki update tool (530) accepts input from the user through the I/O module and makes appropriate changes (if any) to the wiki.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A method comprising:
associating a portion of a wild hosted by a computing device with an electronic reference;
displaying information from the reference in the portion of the wiki;
monitoring the reference for change with the computing device;
if a change is detected by the computing device, then reporting to a user that a reference has changed;
presenting the user with options to update portions of the wiki that are associated with a reference that has changed; and
if the user accepts an option to update portions of the wiki associated with the reference that has changed, then updating the wiki.

2. The method of claim 1, in which associating a portion of a wiki hosted by a computing device comprises identifying the reference by providing an electronically accessible location of the reference.

3. The method of claim 2, in which the location of the reference is a uniform resource locator.

4. The method of claim 1, further comprising selecting a portion of the reference to replace the portion of the wiki.

5. The method of claim 4, in which selecting a portion of the reference to replace the portion of the wiki comprises highlighting a portion of the reference and confirming the selection of the portion of the reference.

6. The method of claim 1, in which displaying information from the reference in the portion of the wiki comprises replacing the portion of the wiki with information from the reference.

7. The method of claim 1, further comprising presenting change notification options to the user for selection.

8. The method of claim 7, in which the change notification options comprise at least one of: sending a text message to the user, sending an email to the user, changing text color of a portion of the wild associated with the reference, and changing an icon located proximate to the portion of the wiki associated with the reference.

9. The method of claim 1, in which monitoring the reference for change comprises maintaining an index of the references and periodically accessing the references to check for changes.

10. The method of claim 1, in which monitoring the references for changes comprises communication with a web browsing robot.

11. The method of claim 1, in which monitoring the references for changes comprises determining if a portion of the reference displayed in the wiki has changed.

12. The method of claim 1, in which reporting to the user that a reference has changed comprises sending periodic compilation of changes to the user.

13. The method of claim 1, in which in which reporting to the user that a reference has changed comprises changing visual characteristics of a portion of the wiki associated with the reference that has changed.

14. A system comprising:
a wiki hosted by a computing device;
a wiki reference tool implemented by a computer processor, the wiki reference tool configured to associate selected portions of a wiki with references;
a wiki update tool implemented by the computer processor, the wiki update tool configured to monitor references associated with portions of the wiki for changes; and
a change notification generated by the wiki update tool and presented to the user when the wild update tool detects a change in one of the references associated with the wiki.

15. The system of claim 14, in which the wiki reference tool comprises a field for entering a location of an external reference to be associated with a selected portion of the wiki.

16. The system of claim 14, in which the references are external references, the wiki update tool configured to periodically access the external references through a network interface to monitor the external references for changes.

17. The system of claim 14, in which the wiki update tool comprises a menu of change notification options.

18. The system of claim 14, in which the change notification comprises altered text displayed in a portion the wiki associated with a changed reference.

19. The system of claim 14, further comprising an update to the wiki based on the user's response to the change notification.

20. A computer program product for implementing a wiki, the computer program product comprising:
a computer readable storage medium having computer readable program code embodied therewith, the computer readable program code comprising:
computer readable program code configured to associate a portion of the wiki with a reference;
computer readable program code configured to display information from the reference in the portion of the wiki;
computer readable program code configured to monitor the reference for change; and
computer readable program code configured to update the portion of the wiki if a change in the reference is detected.
